(19) United States
(12) Patent Application Publication
(10) Pub. No.: US 2025/0133481 A1
(43) Pub. Date: Apr. 24, 2025

(54) RECEIVING SYSTEM INFORMATION FROM A RELAY VIA A SIDELINK CHANNEL

(71) Applicant: Lenovo (Singapore) Pte. Ltd., New Tech Park (SG)

(72) Inventors: Prateek Basu Mallick, Dreieich (DE); Karthikeyan Ganesan, Kronberg im Taunus (DE); Ravi Kuchibhotla, Chicago, IL (US)

(21) Appl. No.: 18/681,450

(22) PCT Filed: Aug. 4, 2022
(86) PCT No.: PCT/IB2022/057276

§ 371 Date: Feb. 5, 2024

Related U.S. Application Data
(60) Provisional application No. 63/229,491, filed on Aug. 4, 2021.

(51) Int. Cl. H04W 48/14; H04W 88/04; H04W 92/18

(52) U.S. Cl. CPC H04W 48/14; H04W 88/04; H04W 92/18

(57) ABSTRACT

Apparatuses, methods, and systems are disclosed for system information delivery over sidelink radio interface using a UE-to-Network relay UE. One method includes transmitting information for SIBs provided by a serving cell in a mobile wireless communication network and receiving, from a remote device, a request for a particular SIB. The method includes acquiring a set of SIBs from the serving cell and transmitting, using a sidelink channel, a valid version of the particular SIB to the remote device.

### CROSS-REFERENCE TO RELATED APPLICATIONS

This application claims priority to U.S. Provisional Patent Application No. 63/229,491 entitled “SYSTEM INFORMATION DELIVERY USING UE-TO-NETWORK SIDELINK RELAY” and filed on 4 Aug. 2021 for Prateek Basu Mallick, Karthikeyan Ganesan, and Ravi Kuchibhotla, which application is incorporated herein by reference.

### FIELD

The subject matter disclosed herein relates generally to wireless communications and more particularly relates to mechanisms for improved communications using relay over sidelink (“SL”) radio interface.

### BACKGROUND

In certain wireless networks, a SL relay may be used to provide service to User Equipment (“UE”) a using one or multiple hops. For UE-to-Network (“U2N”) coverage extension, Uu coverage reachability is necessary for UEs to reach a server in a Packet Data Network (“PDN”) or a counterpart UE out of proximity area. For UE-to-UE (“U2U”) coverage extension, currently proximity reachability is limited to single-hop SL link, either via Evolved UMTS Terrestrial Radio Access (“E-UTRA”) based or Third Generation Partnership Project (“3GPP”) New Radio (“NR”) based SL access technology.

### BRIEF SUMMARY

Disclosed are procedures for system information (“SI”) delivery over SL radio interface using a U2N relay. Said procedures may be implemented by apparatus, systems, methods, or computer program products.

One method at a relay UE includes transmitting, to a remote (i.e., non-relay) UE, information for system information blocks (“SIBs”) provided by a serving cell in a mobile wireless communication network and receiving, from the remote UE, a request for a particular system information block (“SIB”). The method includes acquiring a set of SIBs from the serving cell and transmitting, to the remote UE, a valid version of the particular SIB requested by the remote UE, using a SL channel.

One method at a remote UE includes receiving, from a relay UE, information for SIBs provided by a serving cell in a mobile wireless communication network. The method includes transmitting, to the relay UE, a request for a required SIB and receiving, from the relay UE, a valid version of the required SIB via a SL channel.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for SI delivery over SL radio interface using a U2N relay;

FIG. 2 is a block diagram illustrating one embodiment of a 5G New Radio (“NR”) protocol stack;

FIG. 3 is a block diagram illustrating one embodiment of a SL (e.g., PC5) protocol stack;

FIG. 4 is a block diagram illustrating one embodiment of a relay arrangement and procedure for SI delivery over SL radio interface using a U2N relay;

FIG. 5 is a block diagram illustrating one embodiment of a user equipment apparatus that may be used for SI delivery over SL radio interface using a U2N relay;

FIG. 6 is a block diagram illustrating one embodiment of a network equipment apparatus that may be used for SI delivery over SL radio interface using a U2N relay;

FIG. 7 is a block diagram illustrating one embodiment of a first method for SI delivery over SL radio interface using a U2N relay; and

FIG. 8 is a block diagram illustrating one embodiment of a second method for SI delivery over SL radio interface using a U2N relay.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for SI delivery over SL radio interface using a U2N relay. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Current developments in 3GPP seek to improve includes connection management, SI delivery, paging, access control for remote UE, etc. Among other functions, a NR SL Relay would also be responsible to provide the remote UE with required SI—as was the case for 3GPP Long-Term Evolution (“LTE”).

For LTE, the 3GPP TR 36.746 describes SI reception for evolved Proximity Services (“ProSe”) Remote UE where in the evolved ProSe U2N relay UE supports relaying of SI for the linked evolved ProSe Remote UEs located in-coverage of Evolved Universal Terrestrial Radio Access Network (“E-UTRAN”) coverage as well as out of E-UTRAN coverage.

Regarding SI reception for evolved ProSe Remote UE, the evolved ProSe U2N relay UE supports relaying of SI for the linked evolved ProSe Remote UEs located in-coverage of E-UTRAN coverage as well as out of E-UTRAN coverage. The Evolved Node B (abbreviated as “eNodeB” or “eNB”) can configure the evolved ProSe U2N relay UE whether it can forward the SI to linked in-coverage evolved ProSe Remote UEs. Alternatively, the evolved ProSe U2N relay UE is expected to forward the SI to the in-coverage evolved ProSe Remote UE. The linked evolved ProSe Remote UE utilizes the SI of the serving cell of the evolved ProSe U2N relay UE.

Not all SI is relayed to the linked evolved ProSe Remote UE via the evolved ProSe U2N relay UE. Essential SIBs are required to be relayed from the evolved ProSe U2N relay UE to all linked evolved ProSe Remote UEs commonly. At least the following SIBs can be considered as essential SIBs: MIB (System Frame Number (“SFN”), bandwidth), SIB1 (Public Land Mobile Network (“PLMN”), cell information), SIB2 (Access Barring information), FeD2D SIB related info (e.g., SIB 18 and/or SIB 19 or new SIBs). Evolved ProSe U2N relay UE can optionally forward other SIBs (e.g., SIB 10 and/or SIB 11 and/or SIB 12 and/or SIB 13 and/or SIB 14 and/or SIB 15) depending on the linked evolved ProSe Remote UEs.

However, LTE specifications do not define which other SIBs need to be forwarded to the evolved ProSe Remote UE and what information is provided to the evolved ProSe U2N relay UE to indicate which SIBs are needed by the evolved ProSe Remote UE.

The evolved ProSe U2N relay UE is expected to purely forward the SIBs without changing the information and format of the SIB. This approach is recommended. Alternatively, the evolved ProSe U2N relay UE can only forward a subset of information of the SIB to the evolved ProSe Remote UE. However, LTE specifications do not define whether there is a use case for the evolved ProSe U2N relay UE forwarding only subset of information of the SIB to the evolved ProSe Remote UE.

An evolved ProSe U2N relay UE forwards SIB over SL using broadcast/multi-cast. However, LTE specifications do not define whether unicast transmission is used for evolved ProSe

U2N relay UE forwarding SIB.

The SI is not delivered periodically to the evolved ProSe Remote UE, but only when deemed necessary. The evolved ProSe U2N relay UE can determine that SIB delivery is deemed necessary for the evolved ProSe Remote UE when SI is updated.

While LTE specification mentions “relay UE forwards SIB over sidelink using broadcast/multi-cast,” details of “how” the relay UE forwards a SIB are not described in nor enabled by the LTE specification. For example, the LTE specification does not cover if, or how, or when a group for SI distribution is formed.

In addition, NR has different challenges/opportunities while providing the SI efficiently to the remote UEs, e.g., Hybrid Automatic Repeat Request (“HARQ”) Feedback can be used for data transmission on PC5 interface in NR, Discontinuous Reception (“DRX”) can be used as well. This document solves such problem/challenges and makes use of new opportunities (e.g., HARQ feedback, DRX) offered by NR only. As used herein, “HARQ-ACK” may represent collectively the Positive Acknowledge (“ACK”) and the Negative Acknowledge (“NACK”) and Discontinuous Transmission (“DTX”). Signaling ACK means that a Transport Block (“TB”) is correctly received. Signaling NACK (or NAK) means a TB is erroneously received (e.g., received but unsuccessfully decoded), while signaling DTX means that no TB was detected.

Multi Relay for NR SL is a new study. In previous systems like E-UTRA, the related concept of HARQ feedback was not used and therefore there is not a direct conventional solution available using relay scenarios for increasing reliability and/or coverage.

Disclosed are procedures for SI delivery over SL radio interface using a U2N relay. Said procedures may be implemented by apparatus, systems, methods, or computer program products.

In the context of SI distribution to remote UEs by a U2N relay, NR has different challenges/opportunities while providing the SI efficiently to the remote UEs e.g., HARQ Feedback can be used for data transmission on PC5 interface in NR, DRX can be used as well. This document solves such problem/challenges and makes use of new opportunities (e.g., HARQ feedback, DRX) offered by NR only.

The solutions described herein disclose embodiments for each of the challenges/NR-opportunities. For example, methods are revealed on how HARQ feedback can be used for group-based SI distribution. Another embodiment is disclosing how configuration/derivation of a DRX Cycle configuration, including DRX start offset for SI distribution can be realized in specification.

In one embodiment, information of which SIBs are contained in the corresponding SL data channel (i.e., Physical Sidelink Shared Channel (“PSSCH”)) can be included explicitly in Sidelink Channel Information (“SCI”) using an n-bit bitmap, starting with the first (e.g., most significant) bit each bit corresponds to one SIB (e.g., starting with SIB1 or SIB2) supported by the system, e.g., defined in the 3GPP Technical Specification (“TS”) 38.331 Radio Resource Control (“RRC”) specification. A remote UE uses this information for LI filtering i.e., it decodes PSSCH only if the SIB(s) of interest to it is/are contained therein.

In another embodiment, a U2N relay can retransmit the SI using HARQ feedback. For this purpose, in one implementation a common-resource negative HARQ feedback (so called Option-1 based feedback) can be used. Any UE not successfully receiving the PSSCH can transmit a NACK on the common Physical Sidelink Feedback Channel (“PSFCH”) resources. A U2N relay may retransmit the PSSCH containing SI upon receiving a NACK feedback. This obviates the need for pre-establishing PC5 RRC Connection with the relay to acquire SI of a specific cell by a remote UE.

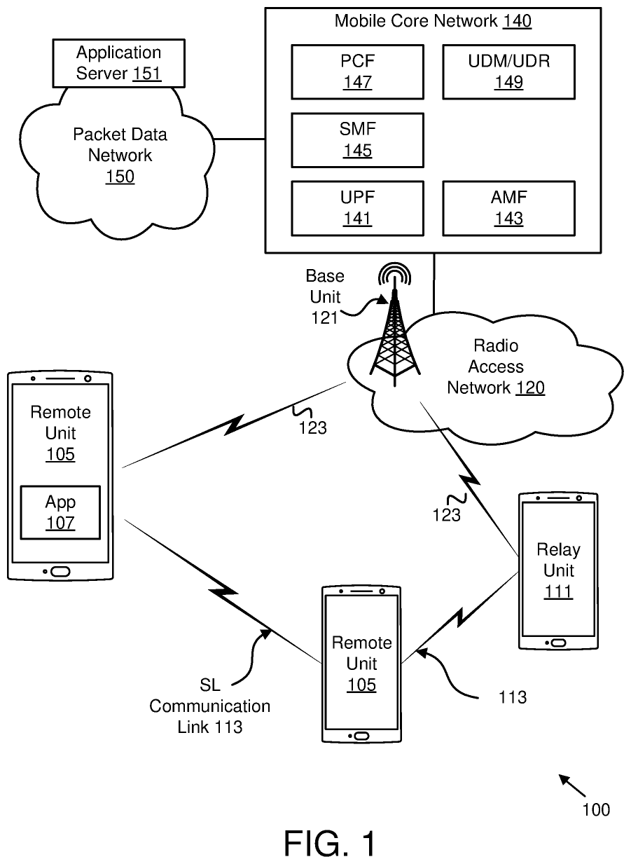

FIG. 1 depicts a wireless communication system 100 for SI delivery over SL radio interface using a U2N relay, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink

Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using SL communication links 113. Here, SL transmissions may occur on SL resources. A remote unit 105 may be provided with different SL communication resources according to different allocation modes. As used herein, a “resource pool” refers to a set of resources assigned for SL operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A

PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or PDN connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an eNB (also known as E-UTRAN Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or PLMN.

The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of NFs are depicted in FIG. 1, one of skill in the art will recognize that any number and type of NFs may be included in the mobile core network 140.

The UPF(s) 141 is/are responsible for packet routing and forwarding, packet inspection, QOS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of NFs. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of NFs, such as the SMF 145 and UPF 141. In some embodiments, the different network slices may share some common NFs, such as the AMF 143. The different network slices are not shown in FIG. 1 for ease of illustration, but their support is assumed.

While FIG. 1 depicts components of a 5G RAN and a 5G core network, the described embodiments for SI delivery over SL radio interface using a U2N relay apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted NFs may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the below described solutions/methods are also equally applicable to other mobile communication systems SI delivery over SL radio interface using a U2N relay.

In various embodiments, the remote units 105 may communicate directly with each other (e.g., device-to-device communication) using SL communication links 113. Here, SL transmissions may occur on SL resources. The remote units 105 implement SL HARQ processes for at least some data transferred over SL communication links 113, as discussed in greater detail below.

In various embodiments, the transmitting remote unit 105 (i.e., source UE) may not

be in range to transmit directly to the receiving remote unit 105 (i.e., destination UE). In such embodiments, the transmitting remote unit 105 may use one or more relay units 111 to reach the receiving remote unit. A relay unit 111 may be one embodiment of the remote unit 105, i.e., a UE configured to relay transmissions over SL communication links 113. The relay unit(s) 111 may relay both data packets and HARQ feedback, as discussed in greater detail below.

As described above, two types of relays are considered herein:

1U2N relay: Uu coverage reachability is necessary for UEs to reach server in PDN network or counterpart UE out of proximity area. However, N-relay solution previously defined in 3GPP Release 13 is limited to E-UTRA-based technology, and thus cannot be applied to NR-based system, for both NG-RAN and NR-based SL communication.

U2U relay: Currently, proximity reachability is limited to single-hop SL link, either via E-UTRA-based or NR-based SL technology. However, that is not sufficient in the scenario where there is no Uu coverage (i.e., the UE is outside of RAN coverage), considering the limited single-hop SL coverage.

For both SL relay types, a SL remote UE needs to discover and select a Relay for transmissions to a SL Remote. The reliability requirement already is 10\hat{ }(−5) and may only increase further with the introduction of Public Safety. In addition, other communication applications—like Industrial Internet-of-Things (“IIoT”), and others-are to start using SL and require not only even higher reliability, but also extended coverage. A SL relay is a potential means to increase coverage using one or multiple hops. Described herein are methods to achieve higher reliability as well as coverage.

In NR Vehicle-to-everything (“V2X”) communication Release 16, SL HARQ feedback is used for groupcast and unicast communication to improve spectral efficiency. Note that V2X communication encompasses both Vehicle-to-Infrastructure (“V2I”) and Vehicle-to-Vehicle (“V2V”). When SL HARQ feedback is enabled for unicast, in the case of non-Code Block Group (“CBG”) operation, the receiver UE (“Rx UE,” i.e., receiving remote unit 105) generates HARQ-ACK if it successfully decodes the corresponding TB. The Rx UE generates HARQ-NACK if it does not successfully decode the corresponding TB after decoding the associated Physical Sidelink Control Channel (“PSCCH”) targeted to the Rx UE.

As for communicating feedback by the receiver UE(s) to the transmitter UE for a transmission made by the transmitter is concerned, following two options are available:

According to SL HARQ feedback Option 1, i.e., NACK only common feedback resource, all receiver(s) that failed to successfully decode the received PSSCH Data packet will send a HARQ NACK on the resource common to all the receivers. The HARQ NACK feedback is SFN combined over the air.

According to SL HARQ feedback Option 2, i.e., Rx UE-specific ACK/NACK feedback resources, every receiver that received PSCCH (SCI) and attempted to decode corresponding PSSCH (Data) shall feedback HARQ ACK/NACK in the corresponding resources depending on if they were successful or not in decoding the Data packet.

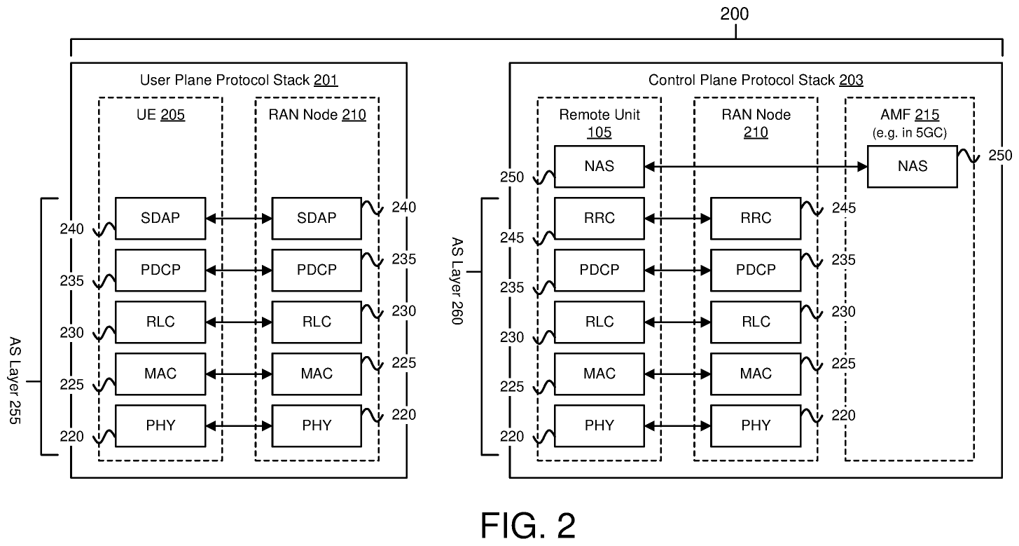

FIG. 2 depicts a protocol stack 200, according to embodiments of the disclosure. While FIG. 2 shows a UE 205, a RAN node 210 (e.g., a gNB) and an AMF 215, e.g. in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes the physical (“PHY”) layer 220, the Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, an RLC sublayer 230, and a PDCP sublayer 235. The Control Plane protocol stack 203 also includes a RRC layer 245 and a NAS layer 250.

The Access Stratum (“AS”) layer 255 (also referred to as “AS protocol stack”) for the User Plane protocol stack 201 consists of at least the SDAP sublayer 240, PDCP sublayer 235, RLC sublayer 230 and the MAC sublayer 225, and the PHY layer 220. The AS layer 260 for the Control Plane protocol stack 203 consists of at least the RRC layer 245, PDCP sublayer 235, RLC sublayer 230, the MAC sublayer 225, and the PHY layer 220. The Layer-1 (“L1”) comprises the PHY layer 220. The Layer-2 (“L2”) is split into the SDAP sublayer 240, PDCP sublayer 235, RLC sublayer 230, and the MAC sublayer 225. The Layer-3 (“L3”) includes the RRC layer 245 and the NAS layer 250 for the control plane and includes, e.g., an IP layer or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 maps QoS flows within a PDU Session to a corresponding Data Radio Bearer over the air interface and the SDAP sublayer 240 interfaces the QoS flows to the 5GC (e.g., to user plane function, UPF). The RRC layer 245 provides for the addition, modification, and release of Carrier Aggregation (“CA”) and/or Dual

Connectivity (“DC”). The RRC layer 245 also manages the establishment, configuration, maintenance, and release of Signaling Radio Bearers (“SRBs”) and Data Radio Bearers (“DRBs”). In certain embodiments, an RRC entity functions for detection of and recovery from radio link failure.

The NAS layer 250 is between the UE 205 and an AMF in the 5GC 509. NAS

messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC layer 230 above is through logical channels. The MAC sublayer 225 therefore performs multiplexing and demultiplexing between logical channels and transport channels: the MAC sublayer 225 in the transmitting side constructs MAC PDUs, known as transport blocks, from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC layer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as DL or UL. Data is multiplexed into transport channels depending on how it is transmitted over the air.

The PHY layer 220 is responsible for the actual transmission of data and control information via the air interface, i.e., the PHY Layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

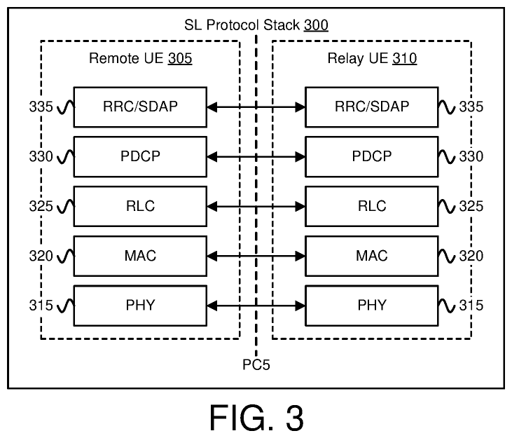

FIG. 3 depicts a PC5 protocol stack 300, according to embodiments of the disclosure. While FIG. 3 shows the remote UE 305 and the relay UE 310, these are representative of a set of UEs communicating peer-to-peer via PC5 and other embodiments may involve different UEs. As depicted, the PC5 protocol stack includes a physical layer 315, a MAC sublayer 320, an RLC sublayer 325, a PDCP sublayer 330, and RRC and SDAP layers (depicted as combined element “RRC/SDAP” 335), for the control plane and user plane, respectively.

The AS protocol stack for the control plane in the PC5 interface consists of at least RRC, PDCP, RLC and MAC sublayers, and the physical layer. The AS protocol stack for the user plane in the PC5 interface consists of at least SDAP, PDCP, RLC and MAC sublayers, and the physical layer. The L2 is split into the SDAP, PDCP, RLC and MAC sublayers. The L3 includes the RRC layer and the NAS layer for the control plane and includes, e.g., an IP layer for the user plane. L1 and L2 are referred to as “lower layers”, while L3 and above (e.g., transport layer, V2X layer, ProSe layer, application layer) are referred to as “higher layers” or “upper layers.”

In some embodiments, the relay UE 310 acts as a L3 relay (also referred to as an IP relay). Here, communication between the remote UE 305 (i.e., source UE) and the RAN Node 210 (i.e., gNB) via L3 relay goes through two links, i.e., a first PC5 link (corresponding to Interface-1) between the remote UE 305 and the relay UE 310 and a second Uu link (corresponding to Interface-2) between the relay UE 310 and the RAN Node 210. In such embodiments, the protocol stack of the relay UE 310 may include SDAP, RRC, PDCP, RLC, MAC and PHY layers which interact with corresponding layers at the remote UE 305 via the Interface-1, and which also interact with corresponding layers at the RAN Node 210 via the Interface-2. In some embodiments, the relay UE 310 may adopt one or more L1 and/or L2 identities of the remote UE 305, e.g., to improve communication over SL relay interface.

In some embodiments, the relay UE 310 acts as a L2 relay. In certain embodiments, the relay UE 310 acting as a L2 relay performs relay function below the PDCP layer 330, such that the relay UE 310 does not perform PDCP, RRC and SDAP functions for the SL communication. In such embodiments, the protocol stack of the relay UE 310 may include RLC layer 325, MAC sublayer 320 and PHY layer 315 entities which interact with corresponding layers at the remote UE 305 via the Interface-1, and which interact with corresponding layers at the RAN Node 210 via the Interface-2. However, for the PDCP layer 330, the RRC and SDAP layers 335, the link endpoints are between the remote UE 305 and the RAN Node 210.

In some embodiments, the relay UE 310 acts as a L1 relay (also referred to as an Amplify and Forward relay) with HARQ functionality. In certain embodiments, the protocol stack of the relay UE 310 may have PHY layer 315 and a HARQ entity (i.e., of the MAC sublayer 320) which interact with corresponding layers at the remote UE 305 via the Interface-1, and which interact with corresponding layers at the RAN Node 210 via the Interface-2. However, for the remaining layers, the link endpoints are between the remote UE 305 and the RAN Node 210.

Note that the above relay descriptions are exemplary, and the relay UE 310 is not limited to the above-described relay implementations. Thus, the relay UE 310 may implement different protocol stacks and/or link endpoints than those described above, according to the below described solutions.

In some embodiments, a respective remote UE 305 sends a request to a respective relay UE 310 to acquire on-demand SIB(s) and forward them to the remote UE 305. A relay UE 310, upon receiving the request from the remote UE 305, may initiate acquisition of the said SIB(s) using on demand SIB acquisition procedure. In some embodiments, special group destination (“DST”) IDs are used for L1, L2 filtering. Using this special group destination ID, a respective relay UE 310 may serve SI demands for multiple remote UEs 305 in a combined manner. Additionally, the relay UE 310 may relay the regularly broadcasted SIBs. The below solutions provide details like composition of said L2 DST ID, HARQ-based transmissions, etc.

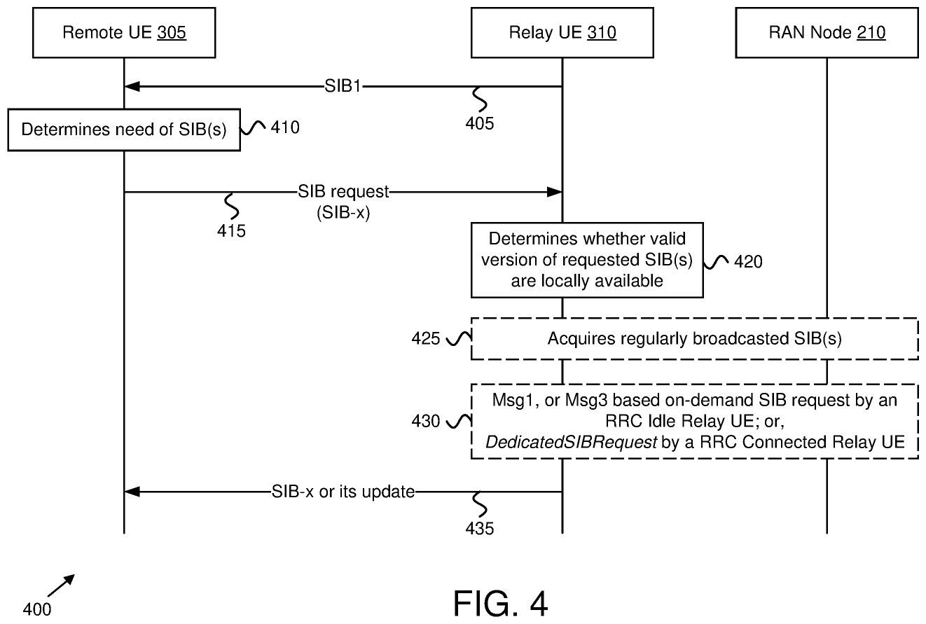

FIG. 4 depicts an exemplary procedure 400 for delivering SI to a remote UE via a U2N relay UE, according to embodiments of the disclosure. FIG. 4 shows an arrangement of a respective remote UE 305 and a respective relay UE 310 (i.e., a U2N relay UE) for the distribution of SI of a serving cell to the remote UE 305. While FIG. 4 does not assume a prior PC5 RRC connection between the but in some embodiments described below this might a pre-requisite. Note that, while linked to the remote UE 305, the relay UE 310 does not need to be in an RRC connected state with respect to the RAN node 210. This is because the relay UE 310 can receive the SI regularly broadcast by the RAN node 210 while in an idle state or inactive state.

The procedure 400 begins as the relay UE 310 sends information to remote UEs 305 (via SL transmission) information on which SIBs are provided by the serving cell of the relay UE 310 (i.e., a serving cell corresponding to the RAN node 210); see signaling 405. In some embodiments, the relay UE 310 transmits SIB1 via SL transmission.

A respective remote UE 305 determines that is needs/requires one or more SIBs provided by the serving cell corresponding to the RAN node 210; see block 410.

The remote UE 305 requests the SIBs that it needs from the relay UE 310 using RRC signaling or a MAC Control Element (“CE”); see signaling 415. In some embodiments, to request the needed SIBs, the remote UE 305 includes an n-bit bitmap in the request message (e.g., RRC signaling and/or MAC CE). In such embodiments, starting with the first (e.g., most significant) bit, each bit of the n-bit bitmap corresponds to one SIB (e.g., starting with SIB1 or SIB2) supported by the system, e.g., defined in the 3GPP TS 38.331 RRC specification.

The relay UE 310 determines whether a valid version of the requested SIB(s) is/are locally available at the relay UE 310; see block 420.

If a valid version of the requested SIB(s) is not locally available at the relay UE 310, then the relay UE 310 acquires a valid version of the requested SIB(s) by acquiring the SI-message(s) that contain the SIB(s) required by the remote UE 305. If a regularly broadcasted SIB is requested, then the relay UE 310 acquires a valid version of the regularly broadcasted SIB(s); see block 425.

If an on-demand SIB is requested, then the relay UE 310 may initiate acquisition of the requested SIB(s) using an on-demand SIB acquisition procedure; see block 430. Where the relay UE 310 is in the RRC Idle state, the on-demand SIB acquisition may be performed using a Msg1-based on-demand SI request or using a Msg3-based on-demand SI request; alternatively, if the relay UE 310 is in the RRC Connected state, then the on-demand SIB acquisition may be performed using a dedicated SIB request procedure. In certain embodiments, the relay UE 310 may combine SIB requests from more than one remote UE 305 and initiate the on-demand SI acquisition together for these UEs.

Upon successful acquisition of a valid version of the requested SIB(s), the relay UE 310 forwards only the required SIB(s) to the remote UE(s) 305, i.e., not the entire SI-message that contained the required SIB(s) in Uu DL SIB transmission; see messaging 435. This allows efficient SI transmission on the PC5 interface by not transmitting SIBs in a SI-message that were not even requested by the remote UE 305 in the first place.

In some embodiments, the system may use of a special L2 destination ID for distribution of the various SIBs for the serving cell to one or more remote UEs 305 via the relay UE 310. Note that the current disclosure encompasses the distribution of regularly provided SI (e.g., broadcast at regular intervals by the RAN node 210), as well as on-demand SIBs. In some embodiments, distribution of SI (regularly provided, as well as on-demand SIBs) by the relay UE 310 to the remote UE(s) 305 is accomplished using group distribution of SI. In other embodiments, distribution of the SI by the relay UE 310 to the remote UE(s) 305 is accomplished using Unicast-based SIB transmissions.

The group distribution of SI can be regarded as a groupcast communication where a relay UE 310 is transmitting to only its linked (i.e., PC5 RRC Connected UEs) UEs. Alternatively, the group distribution of SI can be regarded as a broadcast communication where a relay UE 310 is transmitting SIBs that may be of interest to any remote UE 305, including those who are not PC5 RRC Connected to the said relay.

As first embodiment, applicable only for group distribution, the L2 DST ID is composed out of the hexa-decimal value ‘FFFFFF’. In various embodiments, the hexa-decimal value ‘FFFFFF’ is an extension (or repetition) of the SI-RNTI. In another implementation, a set of at least one L2 DST ID and/or L2 Source (“SRC”) ID may be reserved for the purpose of distributing SI message via unicast, groupcast or broadcast transmissions.

In some embodiments, the L2 DST ID reserved for this purpose by the RAN node 210 (e.g., agNB or similar RAN network node) is communicated to the V2X layer or ProSe Layer so that such DST ID are not allocated for any other application service by V2X layer or ProSe layer.

The following enhancements are applicable for distribution of SI by a relay UE 310 to a remote UE 305 using group distribution or Unicast based transmission:

In one embodiment, information of which SIBs are contained in the corresponding PSSCH can be included explicitly in SCI using an n-bit bitmap, starting with the first (e.g., most significant) bit each bit corresponds to one SIB (e.g., starting with SIB1 or SIB2) supported by the system, e.g., defined in the 3GPP TS 38.331 RRC specification. A remote UE 305 uses this information for LI filtering i.e., it decodes PSSCH only if the SIB(s) of interest to it is contained therein.

In another implementation, one or more L2 DST ID can be associated to SIBs. In one example, one L2 DST ID may be associated to SIB ‘X’ and another L2 DST ID may be associated to SIB ‘Y’. Alternatively, more than one SIBs can be associated with and sent using the same L2 DST ID. The mapping between the one or more SIBs to the L2 DST ID is known to the remote UEs 305 and the relay UE 310 by means of RRC common configuration. As one special case, the L2 DST ID can be associated to SI-messages, e.g., as defined in 3GPP TS 38.331 RRC specification, such that one or more SI-messages can be sent using the same L2 DST ID. Such DST ID may be used to filter the required SIB message at the lower layers.

In another implementation, MAC header/sub-header or MAC CE contain information of the type of SI message transmitted in that PDU. In another implementation, the n-bit bitmap, starting with the first (e.g., most significant) bit each bit corresponds to one SIB (e.g., starting with SIB1 or SIB2) may be contained in the MAC header/sub-header or MAC CE.

In another implementation, no specific L1 or MAC information is contained about which SIBs are included by a relay UE 310 in its SI transmissions. Therefore, a remote UE 305 receives any/all SI, but RRC discards SIBs that it does not need.

In one embodiment, a relay UE 310 can retransmit the SI using HARQ feedback. For this purpose, in one implementation a common-resource negative HARQ feedback (so called groupcast Option-1 based feedback) can be used. Any UE not successfully receiving the PSSCH can transmit a NACK on the common PSFCH resources. A relay UE 310 may retransmit the PSSCH containing SI upon receiving a NACK feedback. This obviates the need for pre-establishing PC5 RRC Connection with the relay to acquire SI of a specific cell by a remote UE 305.

In another implementation, a HARQ Ack/Nack feedback (so called groupcast Option-2 based feedback) can be used such that feedback is sent only by the remote UEs 305 that have already a PC5 RRC Connection established with the relay UE 310. For this purpose, the relay UE 310 already allocates a member ID to the individual remote UE 305 with which a PC5 RRC Connection is already established.

In a further variation, HARQ feedback is sent only by the remote UEs 305 that have already a PC5 RRC Connection established with the relay UE 310 and for SIBs that were requested by it and are provided by the relay UE 310 as indicated in the SCI.

In a further implementation HARQ feedback Nack-only or Ack/Nack) is sent by the remote UEs 305 with an established PC5 connection on determining that the transmission contains SIBs. This could be irrespective of whether the remote UEs 305 specifically requested specific SIBs.

In one embodiment, a relay UE 310 can retransmit the SI using certain number of known (using configuration) blind retransmissions.

In another implementation, configuration from the RAN node 210 may provide information regarding HARQ feedback enable/disable option, HARQ groupcast feedback option or blind retransmission (including maximum number of blind retransmission) for purpose of transmission of SIB messages.

If a DRX cycle is in use between the relay UE 310 and remote UE(s) 305, in one embodiment, the DRX Cycle configuration, including DRX start offset, will be (pre) configured as belonging to a specific PC5 QOS Indicator (“PQI”) and/or said L2 DST ID as used for SI, or even without any association to any of these-to both relay UE 310 and remote UE(s) 305. In one specific implementation, the said DRX cycle can be specified and known to all relay UE 310 and remote UE(s) 305.

In one implementation, the emergency related SIBs like SIB6, SIB7 and SIB8 may not be required by every UE since some remote UEs 305 are just sensor devices-so, remote UEs 305 should let the relay UE 310 know if they need these SIBs. A relay UE 310 distributes such emergency SIBs optionally using a special L2 DST ID on all possible DRX Cycle configuration belonging to any of remote UEs 305. In one implementation, the presence of emergency related SIBs can be explicitly indicated in the SCI using one bit for all emergency related SIBs or using 1 bit each for SIB6, SIB7 and SIB8.

For MAC buffer status reporting, the transmitting PDCP entity shall also consider the PDCP SDUs containing SI as PDCP data volume. The buffer status reporting will be done for the L2 DST ID as described previously.

Currently the priority of SL transmission depends on the Sidelink Logical Channel (“SL-LCH”) across destinations. In one implementation, a certain priority (highest or a bit lower) for the SL LCH used for SI transmission is (pre) configured by the network. As one example this can be considered the highest priority logical channel. The L1 priority (in SCI) can be set accordingly, and a packet delay budget (“PDB”) can be (pre) configured to a certain value. In one specific implementation these priority values (logical channel priority and L1 priority) and the PDB can be set in specification. Note that the PDB relates to the latency of a data packet.

In another implementation, when a mode 1 grant is received in the Logical Channel Prioritization (“LCP”) procedure, priority of the Logical Channels (“LCHs”) containing user data is compared against the priority of the SI message. Priority for LCH carrying SI message is configured by the network or fixed in the specification.

In another implementation, a separate Scheduling Request (“SR”) may be configured for purpose of requesting resource for the transmission of SI message. In another implementation, SR contains information on the size (predetermined size level) of the SI message to be transmitted. In another implementation, when RAN node 210 provides the SI information to the relay UE 310 based on the request, it also provides the Mode 1 grant for the transmission of the SI message via SL.

In another implementation, Configured Grant (“CG”) resource may be configured in SL according to the SI modification period for SL transmission.

For Mode 2 based resource allocation, a new resource (re) selection trigger to perform candidate resource selection (“CRS”) condition for the transmission of the SI message is used. When SIB becomes available for transmission in an LCH, it is considered as “data becomes available for transmission” and the new trigger provides priority and PDB values for the candidate resource selection. Reservation of future resources may be based on the configuration of HARQ retransmission or blind retransmission configuration.

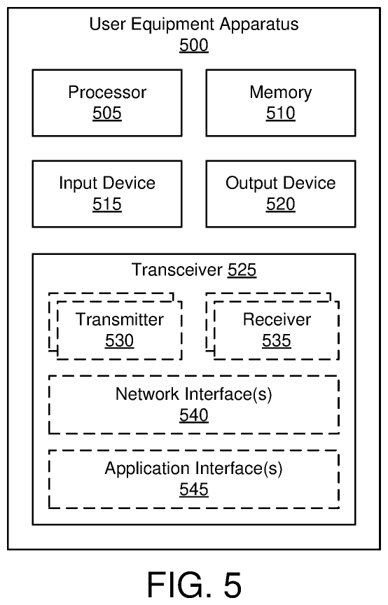

FIG. 5 depicts a user equipment apparatus 500 that may be used for SI delivery over SL radio interface using a U2N relay, according to embodiments of the disclosure. In various embodiments, the user equipment apparatus 500 is used to implement one or more of the solutions described above. The user equipment apparatus 500 may be one embodiment of a UE endpoint, such as the remote unit 105, the relay unit 111, the UE 205, the remote UE 305, and/or the relay UE 310, as described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. In certain embodiments, the processor 505 may include an application processor (also known as “main processor”) which manages application-domain and operating system (“OS”) functions and a baseband processor (also known as “baseband radio processor”) which manages radio functions.

In various embodiments, the processor 505 is configured to cause the apparatus 500 to behave as a relay UE, e.g., a U2N relay. In such embodiments, via the transceiver 525, the processor 505 transmits, to a remote UE, information for SIBs provided by a serving cell in a mobile wireless communication network and receives, from the remote UE, a request for a particular SIB. The processor 505 acquires a set of SIBs from the serving cell and transmits, via the transceiver 525, a valid version of the particular SIB to the remote UE using a SL channel.

In some embodiments, the processor 505 determines whether the valid version of the particular SIB is available in local memory. If the valid version is not available in the local memory, then via the transceiver 525 the processor 505 acquires, from the serving cell, the particular SIB. In certain embodiments, to acquire the particular SIB, the transceiver 525 receives a SI message containing a plurality of SIBs. In such embodiments, to transmit the valid version of the particular SIB, the processor 505 forwards only a requested subset of the plurality of SIBs.

In some embodiments, to transmit the valid version of the particular SIB, the transceiver 525 transmits a PSSCH transmission. In such embodiments, the transceiver 525 further transmits, to the remote UE, SCI that indicates which SIBs are contained in the PSSCH transmission, where the PSSCH transmission includes a unicast transmission, a groupcast transmission, or a broadcast transmission. In certain embodiments, to indicate which SIBs are contained in the PSSCH transmission, the SCI includes a bitmap that indicates the particular SIB.

In some embodiments, to transmit the valid version of the particular SIB, the transceiver 525 transmits to a reserved L2 DST ID. In one embodiment, the reserved L2 DST ID being composed of a hexadecimal value of ‘FFFFFF’. In certain embodiments, the L2 DST ID is a SIB-specific identifier corresponding to the particular SIB.

In some embodiments, to transmit the information for the SIBs provided by the serving cell, the transceiver transmits SIB1 to the remote UE via SL transmission. In such embodiments, the SL transmission includes a unicast transmission, a groupcast transmission, or a broadcast transmission.

In some embodiments, to receive the request for the particular SIB, the transceiver 525 receives RRC signaling including a bitmap that indicates the particular SIB. In other embodiments, the transceiver 525 receives a MAC CE that includes the bitmap that indicates the particular SIB.

In various embodiments, the apparatus 500 includes an in-coverage UE device of the mobile wireless communication network, where the remote UE includes an out-of-coverage UE device or an in-coverage UE device that is not connected to a same serving cell as the apparatus 500.

In various embodiments, the processor 505 is configured to cause the apparatus 500

to behave as a remote UE, e.g., an out-of-coverage UE device or an in-coverage UE device that is not connected to a same serving cell as the relay UE. In such embodiments, via the transceiver 525, the processor 505 receives, from the relay UE, information for SIBs provided by a serving cell in a mobile wireless communication network. In some embodiments, the processor 505 identifies a required SIB, e.g., determines a need/requirement for a particular SIB. Via the transceiver, the processor 505 transmits a request to the relay UE for the required SIB and receives, from the relay UE, a valid version of the required SIB via a SL channel.

In some embodiments, to receive the valid version of the particular SIB, the transceiver 525 receives a PSSCH transmission accompanied by SCI that indicates which SIBs are contained in the PSSCH transmission. In such embodiments, the PSSCH transmission includes a unicast transmission, a groupcast transmission, or a broadcast transmission. In certain embodiments, to indicate which SIBs are contained in the PSSCH transmission, the SCI includes a bitmap that indicates the particular SIB.

In some embodiments, to receive the valid version of the particular SIB, the transceiver 525 receives a transmission having a reserved L2 DST ID, the reserved L2 DST ID being composed of a hexadecimal value of ‘FFFFFF’. In certain embodiments, the L2 DST ID is a SIB-specific identifier corresponding to the particular SIB.

In some embodiments, to receive the information for the SIBs provided by the serving cell, the transceiver 525 receives SIB1 via SL transmission. In such embodiments, the SL transmission includes a unicast transmission, a groupcast transmission, or a broadcast transmission.

In some embodiments, to transmit the request for the particular SIB, the processor 505 is configured to cause the transceiver 525 to transmit RRC signaling including a bitmap that indicates the particular SIB. In other embodiments, the processor 505 is configured to cause the transceiver 525 to transmit a MAC CE that includes the bitmap that indicates the particular SIB.

In some embodiments, the relay UE includes an in-coverage UE device of the mobile wireless communication network, where the apparatus 500 includes an out-of-coverage UE device or an in-coverage UE device that is not connected to a same serving cell as the relay UE.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to SI delivery over SL radio interface using a U2N relay. For example, the memory 510 may store various parameters, panel/beam configurations, resource assignments, policies, and the like as described above. In certain embodiments, the memory 510 also stores program code and related data, such as an operating system or other controller algorithms operating on the user equipment apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more NFs of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

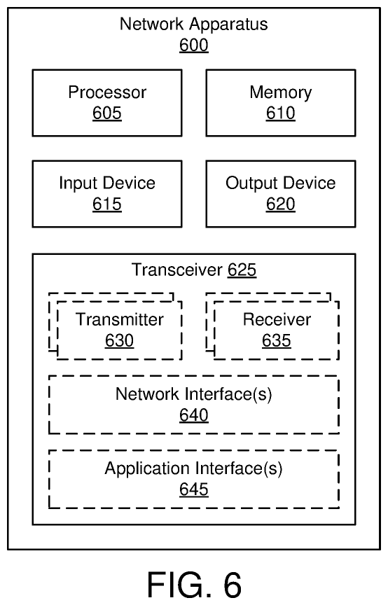

FIG. 6 depicts a network apparatus 600 that may be used for SI delivery over SL radio interface using a U2N relay, according to embodiments of the disclosure. In one embodiment, network apparatus 600 may be one implementation of a network endpoint, such as the base unit 121 and/or RAN node 210, as described above. Furthermore, the network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network apparatus 600 is a RAN node (e.g., gNB) that communicates with one or more UEs, as described herein. In such embodiments, the processor 605 controls the network apparatus 600 to perform the above described RAN behaviors. In some embodiments, the network apparatus 600 may configure one or more endpoint devices with the Training Sequences to be used in the key verification procedure. When operating as a RAN node, the processor 605 may include an application processor (also known as “main processor”) which manages application-domain and operating system (“OS”) functions and a baseband processor (also known as “baseband radio processor”) which manages radio functions.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to SI delivery over SL radio interface using a U2N relay. For example, the memory 610 may store parameters, configurations, resource assignments, policies, and the like, as described above. In certain embodiments, the memory 610 also stores program code and related data, such as an operating system or other controller algorithms operating on the network apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with NFs in the PLMN and/or RAN, as described herein. Although only one transmitter 630 and one receiver 635 are illustrated, the network apparatus 600 may have any suitable number of transmitters 630 and receivers 635.

Further, the transmitter(s) 630 and the receiver(s) 635 may be any suitable type of transmitters and receivers.

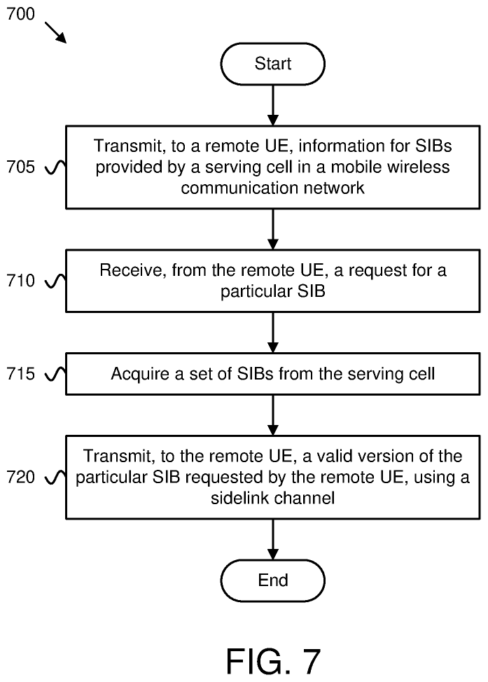

FIG. 7 depicts one embodiment of a method 700 for SI delivery over SL radio interface using a U2N relay, according to embodiments of the disclosure. In various embodiments, the method 700 is performed by a relay device (e.g., a U2N relay UE), such as the relay unit 111, the UE 205, the relay UE 310, and/or the user equipment apparatus 500, as described above. In some embodiments, the method 700 is performed by a processor, such as a microcontroller, a microprocessor, a CPU, a GPU, an auxiliary processing unit, a FPGA, or the like.

The method 700 begins and transmits 705, to a remote UE, information for SIBs provided by a serving cell in a mobile wireless communication network. The method 700 includes receiving 710, from the remote UE, a request for a particular SIB. The method 700 includes acquiring 715 a set of SIBs from the serving cell. The method 700 includes transmitting 720, to the remote UE, a valid version of the particular SIB requested by the remote UE, using a SL channel. The method 700 ends.

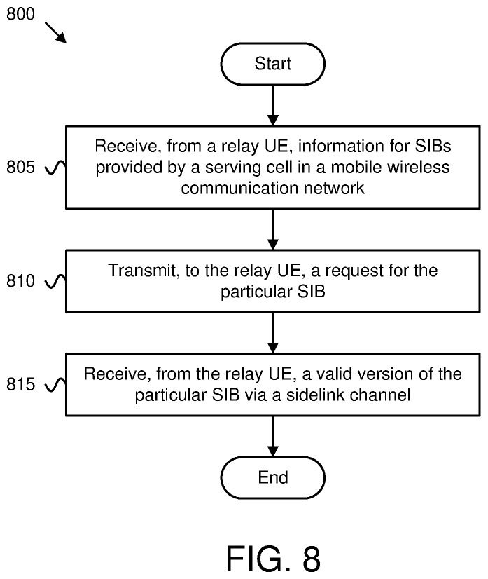

FIG. 8 depicts one embodiment of a method 800 for SI delivery over SL radio interface using a U2N relay, according to embodiments of the disclosure. In various embodiments, the method 800 is performed by a communication device, such as the remote unit 105, the UE 205, the remote UE 310, and/or the user equipment apparatus 500, described above, as described above. In some embodiments, the method 800 is performed by a processor, such as a microcontroller, a microprocessor, a CPU, a GPU, an auxiliary processing unit, a FPGA, or the like.

The method 800 begins and receives 805, from a relay UE (i.e., a U2N relay UE), information for SIBs provided by a serving cell in a mobile wireless communication network. The method 800 includes transmitting 810, to the relay UE, a request for a required SIB. The method 800 includes receiving 815, from the relay UE, a valid version of the required SIB via a SL channel. The method 800 ends.

Disclosed herein is a first apparatus for SI delivery over SL radio interface using a U2N relay, according to embodiments of the disclosure. The first apparatus may be implemented by a relay device (e.g., a U2N relay UE), such as the relay unit 111, the UE 205, the relay UE 310, and/or the user equipment apparatus 500, described above. The first apparatus includes a processor coupled to a transceiver, the transceiver configured to communicate with a serving cell and with a remote UE, where the processor is configured to cause the apparatus to: A) transmit, to the remote UE, information for SIBs provided by a serving cell in a mobile wireless communication network; B) receive, from the remote UE, a request for a particular SIB; C) acquire a set of SIBs from the serving cell; and D) transmit, using a SL channel, a valid version of the particular SIB to the remote UE.

In some embodiments, the processor is further configured to cause the apparatus to: A) determine whether the valid version of the particular SIB is available in local memory; and B) acquire, from the serving cell, the particular SIB, if the valid version is not available in the local memory. In certain embodiments, to acquire the particular SIB, the processor is configured to cause the apparatus to receive a SI message containing a plurality of SIBs. In such embodiments, to transmit the valid version of the particular SIB, the processor is configured to cause the apparatus to forward only a requested subset of the plurality of SIBs.

In some embodiments, to transmit the valid version of the particular SIB, the processor is configured to cause the apparatus to transmit a PSSCH transmission. In such embodiments, the processor is further configured to cause the apparatus to transmit, to the remote UE, SCI that indicates which of the SIBs provided by the serving cell are contained in the PSSCH transmission, where the PSSCH transmission includes a unicast transmission, a groupcast transmission, or a broadcast transmission. In certain embodiments, to indicate which of the SIBs provided by the serving cell are contained in the PSSCH transmission, the SCI includes a bitmap that indicates the particular SIB.

In some embodiments, to transmit the valid version of the particular SIB, the processor is configured to cause the apparatus to transmit to a reserved L2 DST ID. In one embodiment, the reserved L2 DST ID being composed of a hexadecimal value of ‘FFFFFF’. In certain embodiments, the L2 DST ID is a SIB-specific identifier corresponding to the particular SIB.

In some embodiments, to transmit the information for the SIBs provided by the serving cell, the processor is configured to cause the apparatus to transmit SIB1 to the remote UE via SL transmission. In such embodiments, the SL transmission includes a unicast transmission, a groupcast transmission, or a broadcast transmission.

In some embodiments, to receive the request for the particular SIB, the processor is configured to cause the apparatus to receive RRC signaling including a bitmap that indicates the particular SIB. In other embodiments, the processor is configured to cause the apparatus to receive a MAC CE that includes the bitmap that indicates the particular SIB.

In various embodiments, the first apparatus (i.e., a relay UE) includes an in-coverage UE device of the mobile wireless communication network, where the remote UE includes an out-of-coverage UE device or an in-coverage UE device that is not connected to a same serving cell as the first apparatus.

Disclosed herein is a first method for SI delivery over SL radio interface using a U2N relay, according to embodiments of the disclosure. The first method may be performed by a relay device (e.g., a U2N relay UE), such as the relay unit 1101, the UE 205, the relay UE 310, and/or the user equipment apparatus 500, described above. The first method includes transmitting, to a remote UE, information for SIBs provided by a serving cell in a mobile wireless communication network and receiving, from the remote UE, a request for a particular SIB. The first method includes acquiring a set of SIBs from the serving cell and transmitting, to the remote UE, a valid version of the particular SIB requested by the remote UE, using a SL channel.

In some embodiments, the first method further includes determining, at the relay UE, whether the valid version of the particular SIB is available in local memory. In such embodiments, if the valid version is not available in the local memory, then the first method includes acquiring the particular SIB from the serving cell. In certain embodiments, acquiring the particular SIB includes receiving a SI message containing a plurality of SIBs. In such embodiments, transmitting the valid version of the particular SIB includes forwarding only a requested subset of the plurality of SIBs.

In some embodiments, transmitting the valid version of the particular SIB includes transmitting a PSSCH transmission. In such embodiments, the first method further includes transmitting, to the remote UE, SCI that indicates which of the SIBs provided by the serving cell are contained in the PSSCH transmission, where the PSSCH transmission includes a unicast transmission, a groupcast transmission, or a broadcast transmission. In certain embodiments, to indicate which of the SIBs provided by the serving cell are contained in the PSSCH transmission, the SCI includes a bitmap that indicates the particular SIB.

In some embodiments, transmitting the valid version of the particular SIB includes transmitting to a reserved L2 DST ID, the reserved L2 DST ID being composed of a hexadecimal value of ‘FFFFFF’. In certain embodiments, the L2 DST ID is a SIB-specific identifier corresponding to the particular SIB.

In some embodiments, transmitting the information for the SIBs provided by the serving cell includes transmitting SIB1 to the remote UE via SL transmission. In such embodiments, the SL transmission includes a unicast transmission, a groupcast transmission, or a broadcast transmission.

In some embodiments, receiving the request for the particular SIB includes receiving RRC signaling including a bitmap that indicates the particular SIB. In other embodiments, receiving the request for the particular SIB may include receiving a MAC CE including the bitmap that indicates the particular SIB.

In various embodiments, the relay UE includes an in-coverage UE device of the mobile wireless communication network, where the remote UE includes an out-of-coverage UE device or an in-coverage UE device that is not connected to a same serving cell as the relay UE.

Disclosed herein is a second apparatus for SI delivery over SL radio interface using a U2N relay, according to embodiments of the disclosure. The second apparatus may be implemented by a communication device, such as a remote unit 105, a UE 205, the remote UE 305, and/or the user equipment apparatus 500, described above. The second apparatus includes a processor coupled to a transceiver, the transceiver configured to communicate with a relay UE, where the processor is configured to cause the apparatus to: A) receive, from the relay UE, information for SIBs provided by a serving cell in a mobile wireless communication network; B) transmit, to the relay UE, a request for a required SIB; and C) receive, from the relay UE, a valid version of the required SIB via a SL channel.

In some embodiments, to receive the valid version of the required SIB, the processor is configured to cause the apparatus to receive a PSSCH transmission accompanied by SCI that indicates which of the SIBs provided by the serving cell are contained in the PSSCH transmission. In such embodiments, the PSSCH transmission includes a unicast transmission, a groupcast transmission, or a broadcast transmission. In certain embodiments, to indicate which of the SIBs provided by the serving cell are contained in the PSSCH transmission, the SCI includes a bitmap that indicates the required SIB.

In some embodiments, to receive the valid version of the required SIB, the processor is configured to cause the apparatus to receive a transmission having a reserved L2 DST ID, the reserved L2 DST ID being composed of a hexadecimal value of ‘FFFFFF’. In certain embodiments, the L2 DST ID is a SIB-specific identifier corresponding to the required SIB.

In some embodiments, to receive the information for the SIBs provided by the serving cell, the processor is configured to cause the apparatus to receive SIB1 via SL transmission. In such embodiments, the SL transmission includes a unicast transmission, a groupcast transmission, or a broadcast transmission.

In some embodiments, to transmit the request for the required SIB, the processor is configured to cause the apparatus to transmit RRC signaling including a bitmap that indicates the required SIB. In other embodiments, the processor is configured to cause the apparatus to transmit a MAC CE that includes the bitmap that indicates the required SIB.

In some embodiments, the relay UE includes an in-coverage UE device of the mobile wireless communication network, where the second apparatus (i.e., a remote UE) includes an out-of-coverage UE device or an in-coverage UE device that is not connected to a same serving cell as the relay UE.

Disclosed herein is a second method for SI delivery over SL radio interface using a U2N relay, according to embodiments of the disclosure. The second method may be performed by a communication device, such as a remote unit 105, a UE 205, the remote UE 305, and/or the user equipment apparatus 500, described above. The second method includes receiving, from a relay UE (e.g., a U2N relay), information for SIBs provided by a serving cell in a mobile wireless communication network. The method includes transmitting, to the relay UE, a request for a required SIB and receiving, from the relay UE, a valid version of the required SIB via a SL channel.

In some embodiments, receiving the valid version of the required SIB includes receiving a PSSCH transmission accompanied by SCI that indicates which of the SIBs provided by the serving cell are contained in the PSSCH transmission. In such embodiments, the PSSCH transmission may include a unicast transmission, a groupcast transmission, or a broadcast transmission. In certain embodiments, to indicate which of the SIBs provided by the serving cell are contained in the PSSCH transmission, the SCI includes a bitmap that indicates the required

SIB.

In some embodiments, receiving the valid version of the required SIB includes receiving a transmission having a reserved L2 DST ID. In one embodiment, the reserved L2 DST ID being composed of a hexadecimal value of ‘FFFFFF’. In certain embodiments, the L2 DST ID is a SIB-specific identifier corresponding to the required SIB.

In some embodiments, receiving the information for the SIBs provided by the serving cell includes receiving SIB1 via SL transmission. In certain embodiments, the SL transmission includes a unicast transmission, a groupcast transmission, or a broadcast transmission.

In some embodiments, transmitting the request for the required SIB includes transmitting RRC signaling including a bitmap that indicates the required SIB. In some embodiments, transmitting the request for the required SIB includes transmitting a MAC CE including the bitmap that indicates the required SIB.

In various embodiments, the relay UE includes an in-coverage UE device of the mobile wireless communication network, where the remote UE includes an out-of-coverage UE device or an in-coverage UE device that is not connected to a same serving cell as the relay UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A relay apparatus comprising:
a transceiver configured to communicate with remote user equipment (“UE”) and with a serving cell in a mobile wireless communication network;
a processor coupled to the transceiver, the processor configured to cause the apparatus to:
transmit, to the remote UE, information for system information blocks (“SIBs”) provided by the serving cell;
receive, from the remote UE, a request for a particular system information block (“SIB”);
acquire a set of SIBs from the serving cell; and
transmit, to the remote UE, a valid version of the particular SIB requested by the remote UE, using a sidelink channel.

2. The apparatus of claim 1, wherein the processor is further configured to cause the apparatus to:
determine whether the valid version of the particular SIB is available in local memory; and
acquire, from the serving cell, the particular SIB, if the valid version is not available in the local memory.

3. The apparatus of claim 2, wherein, to acquire the particular SIB, the processor is configured to cause the apparatus to receive a system information message containing a plurality of SIBs, and wherein, to transmit the valid version of the particular SIB, the processor is configured to cause the apparatus to forward only a requested subset of the plurality of SIBs.

4. The apparatus of claim 1, wherein, to transmit the valid version of the particular SIB, the processor is configured to cause the apparatus to transmit a physical sidelink data channel (“PSSCH”) transmission, wherein the processor is further configured to cause the apparatus to:
transmit, to the remote UE, sidelink control information (“SCI”) that indicates which of the SIBs provided by the serving cell are contained in the PSSCH transmission,
wherein the PSSCH transmission comprises a unicast transmission, a groupcast transmission, or a broadcast transmission.

5. The apparatus of claim 4, wherein, to indicate which of the SIBs provided by the serving cell are contained in the PSSCH transmission, the SCI comprises a bitmap that indicates the particular SIB.

6. The apparatus of claim 1, wherein, to transmit the valid version of the particular SIB, the processor is configured to cause the apparatus to transmit to a reserved Layer-2 Destination Identifier (“L2 DST ID”), the reserved L2 DST ID being composed of a hexadecimal value of ‘FFFFFF’.

7. The apparatus of claim 6, wherein the L2 DST ID is a SIB-specific identifier corresponding to the particular SIB.

8. The apparatus of claim 1, wherein, to transmit the information for the SIBs provided by the serving cell, the processor is configured to cause the apparatus to transmit System Information Block #1 (“SIB1”) to the remote UE via sidelink transmission, wherein the sidelink transmission comprises a unicast transmission, a groupcast transmission, or a broadcast transmission.

9. The apparatus of claim 1, wherein, to receive the request for the particular SIB, the processor is configured to cause the apparatus to receive Radio Resource Control (“RRC”) signaling comprising a bitmap that indicates the particular SIB.

10. A method of a relay User Equipment (“UE”), the method comprising:
transmitting, to a remote UE, information for system information blocks (“SIBs”) provided by a serving cell in a mobile wireless communication network;
receiving, from the remote UE, a request for a particular system information block (“SIB”);
acquiring a set of SIBs from the serving cell; and
transmitting, to the remote UE, a valid version of the particular SIB requested by the remote UE, using a sidelink channel.

11. A user equipment (“UE”) apparatus comprising:
a transceiver configured to communicate with a relay UE;
a processor coupled to the transceiver, the processor configured to cause the apparatus to:
receive, from the relay UE, information for system information blocks (“SIBs”) provided by a serving cell in a mobile wireless communication network;
transmit, to the relay UE, a request for a required system information block (“SIB”); and
receive, from the relay UE, a valid version of the required SIB via a sidelink channel.

12. The apparatus of claim 11, wherein, to receive the valid version of the required SIB, the processor is configured to cause the apparatus to receive a physical sidelink data channel (“PSSCH”) transmission accompanied by sidelink control information (“SCI”) that indicates which of the SIBs provided by the serving cell are contained in the PSSCH transmission, the PSSCH transmission comprising a unicast transmission, a groupcast transmission, or a broadcast transmission.

13. The apparatus of claim 11, wherein, to receive the information for the SIBs provided by the serving cell, the processor is configured to cause the apparatus to receive System Information Block #1 (“SIB1”) via sidelink transmission, the sidelink transmission comprising a unicast transmission, a groupcast transmission, or a broadcast transmission.

14. The apparatus of claim 11, wherein, to transmit the request for the required SIB, the processor is configured to cause the apparatus to transmit Radio Resource Control (“RRC”) signaling comprising a bitmap that indicates the required SIB.

15. The apparatus of claim 11, wherein the relay UE comprises an in-coverage UE device of the mobile wireless communication network, wherein the apparatus comprises an out-of-coverage UE device or an in-coverage UE device that is not connected to a same serving cell as the relay UE.
